(19) United States
(12) Patent Application Publication
(10) Pub. No.: US 2013/0100450 A1
(43) Pub. Date: Apr. 25, 2013

(54) APPARATUS FOR DETERMINING OPTICAL DENSITY OF LIQUID SAMPLE AND OPTICAL WAVEGUIDE THEREOF

(71) Applicant: Amit Bhatnagar, Mumbai (IN)

(72) Inventor: Amit Bhatnagar, Mumbai (IN)

(21) Appl. No.: 13/809,592

(22) PCT Filed: Jul. 22, 2011
(86) PCT No.: PCT/IB11/01706

§ 371 Date: Jan. 11, 2013

(30) Foreign Application Priority Data
Jul. 22, 2010 (IN) 2084/MUM/2010

(51) Int. Cl. G02B 6/26; G01N 21/17

(52) U.S. Cl. CPC G02B 6/26; G01N 21/17
USPC 356/436; 385/31

(57) ABSTRACT

The present invention provides an optical waveguide, comprising: an input end for receiving a divergent beam; an output end for outputting an illuminating beam; a longitudinal cavity extending from the input end till the output end; a first pinhole located at a first predetermined distance from the input end within the said longitudinal cavity for receiving the divergent beam and for generating a fringe pattern, said first pinhole bifurcating the longitudinal cavity into a first and a second light propagating regions, the longitudinal cavity forming the first light propagating region being provided with a reflective coating on its internal surface to enable internal reflection of the divergent beam; and a second pinhole located at the output end for receiving the fringe pattern thus generated by the first pinhole and for outputting the illuminating beam corresponding to a central bright fringe contained in the said fringe pattern via the output end.

### FIELD OF THE INVENTION

The present invention generally relates to the field of colorimetric analysis. More particularly, the present invention relates to an apparatus for determining optical density of a liquid sample and an optical waveguide therefore.

### BACKGROUND OF THE INVENTION

Heretofore many techniques and instruments are known in the art for generating parallel beam of light. Most of these techniques and instruments use optical equipments such as lenses, slits, etc., for generating parallel beam of light. However, such conventional techniques and instruments are not efficient and the light beam generated exhibits high level/degree of divergence. Further, by using such techniques and instruments, it is very difficult to get a light beam of required intensity. This is due to the reason that, such techniques and instruments are not able to prevent loss of light as the light beam traverses from one location to another. Moreover, such techniques and instruments are complex, costly, inaccurate and require lot of maintenance.

It is to be noted that, parallel beam of light is required in many fields of technology/industry. More specifically, parallel beam of light is very critical in certain areas. Particularly, in the field of colorimetric analysis wherein a parallel beam of light is required to pass through a liquid sample for accurately determining the optical density (absorbance) of the sample. Accordingly, generation of parallel beam of light is very much required and exhibition of divergence will cause errors and the results will vary to a large extent.

As it is conventionally known, colorimetric analysis is performed using a device called colorimeter. A colorimeter is a device used for determining concentration of a liquid sample. A colorimeter works on the principle that concentration of a liquid sample is directly proportional to the optical density (absorbance) of that sample. In other words, a colorimeter determines concentration by measuring optical density (absorbance).

In conventional colorimeters, when a divergent light beam enters a cuvette holding a liquid sample, depending on the concentration of the sample, some amount of light is absorbed and the rest is transmitted. The transmitted light is incident onto a sensor/detector for determining intensity of the transmitted light beam. On the basis of the intensity of the transmitted light beam, transmittance of the liquid sample can be determined. Once the transmittance is determined, optical density (absorbance) of the liquid sample can also be determined.

However, accurate measurement of transmittance and thus optical density (absorbance) is affected by refraction of light which takes place when the light beam enters the cuvette. When the divergent light beam enters the cuvette it gets refracted. The light beam emerging out of the cuvette i.e. the transmitted light beam is a dense light beam having a distance shift. The distance shift varies with the variation in the refractive index of the sample which in turn varies with the variation in the concentration of the sample. When this dense light beam is incident onto the sensor/detector for determining intensity of the transmitted light beam, the sensor/detector gives an error reading, which is a combination of transmittance and refraction of light. Errors are introduced due to refraction of light. Errors encountered in the measurement of transmittance results in errors in the measurement of optical density (absorbance) which in turn results in errors in determination of concentration.

Therefore, there always existed a need to develop a device/instrument for generating parallel beam of light that overcomes the above mentioned disadvantages and which can be used for accurately determining optical density of a liquid sample.

### OBJECTS OF THE INVENTION

An object of the present invention is to generate a parallel beam of light.

Another object of the present invention is to accurately determine optical density (absorbance) of a liquid sample.

### STATEMENT OF THE INVENTION

Accordingly, the present invention provides an optical waveguide, comprising: an input end for receiving a divergent beam; an output end for outputting an illuminating beam; a longitudinal cavity extending from the input end till the output end; a first pinhole located at a first predetermined distance from the input end within the said longitudinal cavity for receiving the divergent beam and for generating a fringe pattern, said first pinhole bifurcating the longitudinal cavity into a first and a second light propagating regions, the longitudinal cavity forming the first light propagating region being provided with a reflective coating on its internal surface to enable internal reflection of the divergent beam; and a second pinhole located at the output end for receiving the fringe pattern thus generated by the first pinhole and for outputting the illuminating beam corresponding to a central bright fringe contained in the said fringe pattern via the output end.

The present invention also provides an apparatus for determining optical density of a liquid sample, said apparatus comprising: a light source emitting a divergent beam; an optical waveguide for receiving the divergent beam at its input and providing an illuminating beam at its output; a cuvette located adjacent to the output of the optical waveguide and configured to hold the liquid sample; and a photo detector located adjacent to the cuvette such that the cuvette is sandwiched between the photo detector and the optical waveguide; characterized in that the optical waveguide comprises: an input end for receiving the divergent beam; an output end for outputting the illuminating beam; a longitudinal cavity extending from the input end till the output end; a first pinhole located at a first predetermined distance from the input end within the said longitudinal cavity for receiving the divergent beam and for generating a fringe pattern, said first pinhole bifurcating the longitudinal cavity into a first and a second light propagating regions, the longitudinal cavity forming the first light propagating region being provided with a reflective coating on its internal surface to enable internal reflection of the divergent beam; and a second pinhole located at the output end for receiving the fringe pattern thus generated by the first pinhole and for directing the illuminating beam corresponding to a central bright fringe contained in the said fringe pattern onto the said cuvette via the output end.

### SUMMARY OF THE INVENTION

Accordingly, the present invention provides an optical waveguide, comprising: an input end for receiving a divergent beam; an output end for outputting an illuminating beam; a longitudinal cavity extending from the input end till the output end; a first pinhole located at a first predetermined distance from the input end within the said longitudinal cavity for receiving the divergent beam and for generating a fringe pattern, said first pinhole bifurcating the longitudinal cavity into a first and a second light propagating regions, the longitudinal cavity forming the first light propagating region being provided with a reflective coating on its internal surface to enable internal reflection of the divergent beam; and a second pinhole located at the output end for receiving the fringe pattern thus generated by the first pinhole and for outputting the illuminating beam corresponding to a central bright fringe contained in the said fringe pattern via the output end.

The present invention also provides an apparatus for determining optical density of a liquid sample, said apparatus comprising: a light source emitting a divergent beam; an optical waveguide for receiving the divergent beam at its input and providing an illuminating beam at its output; a cuvette located adjacent to the output of the optical waveguide and configured to hold the liquid sample; and a photo detector located adjacent to the cuvette such that the cuvette is sandwiched between the photo detector and the optical waveguide; characterized in that the optical waveguide comprises: an input end for receiving the divergent beam; an output end for outputting the illuminating beam; a longitudinal cavity extending from the input end till the output end; a first pinhole located at a first predetermined distance from the input end within the said longitudinal cavity for receiving the divergent beam and for generating a fringe pattern, said first pinhole bifurcating the longitudinal cavity into a first and a second light propagating regions, the longitudinal cavity forming the first light propagating region being provided with a reflective coating on its internal surface to enable internal reflection of the divergent beam; and a second pinhole located at the output end for receiving the fringe pattern thus generated by the first pinhole and for directing the illuminating beam corresponding to a central bright fringe contained in the said fringe pattern onto the said cuvette via the output end.

In the above paragraphs the most important features of the invention have been outlined, in order that the detailed description thereof that follows may be better understood and in order that the present contribution to the art may be better understood and in order that the present contribution to the art may be better appreciated. There are, of course, additional features of the invention that will be described hereinafter and which will form the subject of the claims appended hereto. Those skilled in the art will appreciate that the conception upon which this disclosure is based may readily be utilized as a basis for the designing of other structures for carrying out the several purposes of the invention. It is important therefore that the claims be regarded as including such equivalent constructions as do not depart from the spirit and scope of the invention.

### BRIEF DESCRIPTION OF THE DRAWINGS

Further aspects and advantages of the present invention will be readily understood from the following detailed description with reference to the accompanying drawings, where like reference numerals refer to identical or functionally similar elements throughout the separate views. The figures together with the detailed description below, are incorporated in and form part of the specification, and serve to further illustrate the aspects and explain various principles and advantages, in accordance with the present invention wherein:

FIG. 1, is an exemplary illustration of the optical waveguide according to the present invention.

FIG. 2, illustrates the pattern of illuminating beam according to the present invention.

FIG. 3, is an exemplary illustration of the apparatus for determining optical density of a liquid sample according to the present invention.

FIG. 4 is an exemplary illustration of the longitudinal casing according to the present invention.

FIG. 5, is an exemplary illustration of the light source according to the present invention.

FIG. 6, is an exemplary illustration of the apparatus for determining optical density of a liquid sample according to an aspect of the present invention.

Skilled artisans will appreciate that elements in the drawings are illustrated for simplicity and have not necessarily been drawn to scale. For example, the dimensions of some of the elements in the drawings may be exaggerated relative to other elements to help to improve understanding of aspects of the present invention.

### DETAILED DESCRIPTION OF THE INVENTION

The present invention will be described herein below with reference to the accompanying drawings. In the following description well known functions or constructions are not described in detail since they would obscure the description with unnecessary detail.

Accordingly, the present invention provides an optical waveguide, comprising: an input end for receiving a divergent beam; an output end for outputting an illuminating beam; a longitudinal cavity extending from the input end till the output end; a first pinhole located at a first predetermined distance from the input end within the said longitudinal cavity for receiving the divergent beam and for generating a fringe pattern, said first pinhole bifurcating the longitudinal cavity into a first and a second light propagating regions, the longitudinal cavity forming the first light propagating region being provided with a reflective coating on its internal surface to enable internal reflection of the divergent beam; and a second pinhole located at the output end for receiving the fringe pattern thus generated by the first pinhole and for outputting the illuminating beam corresponding to a central bright fringe contained in the said fringe pattern via the output end.

According to an aspect the present invention provides an optical waveguide wherein the first predetermined distance is selected such that the first light propagating region is substantially long as compared to the second light propagating region.

According to another aspect the present invention provides an optical waveguide wherein the illuminating beam corresponding to the central bright fringe is at zero degree angle of incidence with respect to the second pinhole.

According to another aspect the present invention provides an optical waveguide wherein the waveguide is in the form of a cylinder.

According to another aspect the present invention provides an apparatus for determining optical density of a liquid sample, said apparatus comprising: a light source emitting a divergent beam; an optical waveguide for receiving the divergent beam at its input and providing an illuminating beam at its output; a cuvette located adjacent to the output of the optical waveguide and configured to hold the liquid sample; and a photo detector located adjacent to the cuvette such that the cuvette is sandwiched between the photo detector and the optical waveguide; characterized in that the optical waveguide comprises: an input end for receiving the divergent beam; an output end for outputting the illuminating beam; a longitudinal cavity extending from the input end till the output end; a first pinhole located at a first predetermined distance from the input end within the said longitudinal cavity for receiving the divergent beam and for generating a fringe pattern, said first pinhole bifurcating the longitudinal cavity into a first and a second light propagating regions, the longitudinal cavity forming the first light propagating region being provided with a reflective coating on its internal surface to enable internal reflection of the divergent beam; and a second pinhole located at the output end for receiving the fringe pattern thus generated by the first pinhole and for directing the illuminating beam corresponding to a central bright fringe contained in the said fringe pattern onto the said cuvette via the output end.

According to yet another aspect the present invention provides an apparatus for determining optical density of a liquid sample wherein the first predetermined distance is selected such that the first light propagating region is substantially long as compared to the second light propagating region.

According to yet another aspect the present invention provides an apparatus for determining optical density of a liquid sample wherein the illuminating beam corresponding to the central bright fringe is at zero degree angle of incidence with respect to the cuvette.

According to yet another aspect the present invention provides an apparatus for determining optical density of a liquid sample wherein the waveguide is in the form of a cylinder.

According to yet another aspect the present invention provides an apparatus for determining optical density of a liquid sample wherein the light source is a monochromatic light source or a white light source.

According to yet another aspect the present invention provides an apparatus for determining optical density of a liquid sample wherein when the light source is a white light source, the apparatus further comprises: an optical filter located between the optical waveguide and the cuvette for selecting a predetermined wavelength of the illuminating beam.

According to yet another aspect the present invention provides an apparatus for determining optical density of a liquid sample wherein the optical waveguide is securely fitted inside a longitudinal casing having open proximal and distal ends. According to still another aspect the present invention provides an apparatus for determining optical density of a liquid sample wherein a top wall of the longitudinal casing is provided with a slot in close proximity to the distal end to hold the cuvette.

According to still another aspect the present invention provides an apparatus for determining optical density of a liquid sample wherein the light source is securely fitted at the proximal end.

According to still another aspect the present invention provides an apparatus for determining optical density of a liquid sample wherein the photo detector is securely fitted at the distal end.

According to a further aspect the present invention provides an apparatus for determining optical density of a liquid sample wherein said top wall is provided with a protrusion extending vertically upwards from said slot for providing support to the cuvette, said protrusion being provided with an opening concurrent to the said slot.

According to a still further aspect the present invention provides an optical waveguide and an apparatus for determining optical density of a liquid sample substantially as herein described with reference to the foregoing specification and accompanying drawings.

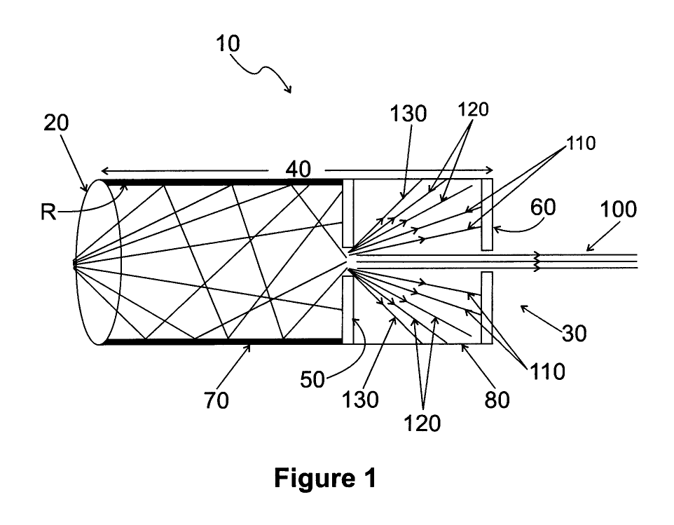

The following paragraphs describe the present invention with reference to FIGS. 1-5.

FIG. 1, shows the structure of the optical waveguide (10) according to the present invention.

As shown in FIG. 1, the optical waveguide (10) is defined by an input end (20), an output end (30) and a longitudinal cavity (40). The longitudinal cavity (40) extends from the input end (20) till output end (30) and defines a space for propagation of light. The said waveguide (10) comprises of a first pinhole (50) located at a first predetermined distance from the input end (20) within the said cavity (40) and a second pinhole (60) located at the output end (30) of the said cavity (40). The first pinhole (50) is located such that it bifurcates the longitudinal cavity (40) into a first light propagating region (70) and a second light propagating region (80). As it can be seen from FIG. 1, the first predetermined distance is selected such that the first light propagating region (70) is substantially long as compared to the second light propagating region (80).

Further, it can be noticed from FIG. 1, the optical waveguide (10) is in the form of a cylinder.

Now coming on to the operation of said optical waveguide (10), it can be noticed from FIG. 1, the input end (20) is configured for receiving a divergent beam and directing the same into the first light propagating region (70). The first light propagating region (70) is provided with a reflective coating (R) on its internal surface to enable internal reflection of the divergent beam. The divergent beam after experiencing reflection within the first light propagating region (70) is incident onto the first pinhole (50). The first pinhole (50) is configured for receiving the divergent beam and for generating a fringe pattern (90).

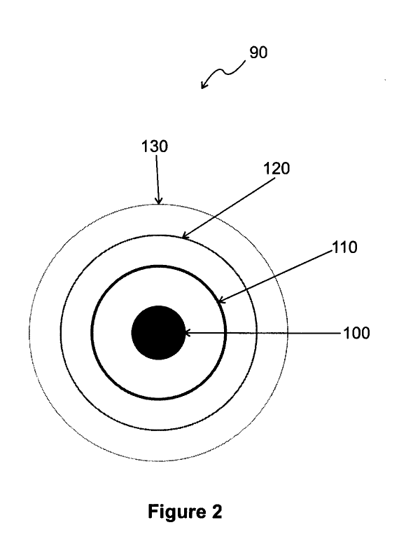

The fringe pattern (90) generated by the first pinhole (50) is referred to as “illuminating beam” and is shown in FIG. 2. As shown in FIG. 2, the fringe pattern (90) comprises of a central bright fringe (100), a first bright fringe (110), a second bright fringe (120) and a third bright fringe (130). It should be noticed that fourth, fifth and further bright fringes also exist, however they are not shown as their intensity is very low. Further, it should be noted that the central bright fringe has the maximum intensity and the intensity decreases with the increase in the order of the fringes.

Referring back to FIG. 1, it can be noticed that the fringe pattern (90) generated by the first pinhole (50) propagates through the second light propagating region (80) and is incident onto the second pinhole (60). The second pinhole (60) is configured for receiving the fringe pattern (90) generated by the first pinhole (50) and for outputting the illuminating beam corresponding to the central bright fringe (100) via the output end (30). In other words, the second pinhole (60) allows only the illuminating beam corresponding to the central bright fringe (100) to pass through and blocks the illuminating beam corresponding to rest of the fringes.

It is important to note that the illuminating beam corresponding to the central bright fringe (100) is at zero degree angle of incidence with respect to the second pinhole (60). On the other hand, the illuminating beam corresponding to rest of the fringes exhibit low level/degree of divergence i.e. it is not exactly at zero degree angle of incidence with respect to the second pinhole (60).

The optical waveguide (10) of the present invention finds applications in many fields of technology/industry. More specifically, the said waveguide (10) is of great significance in the fields where there is a requirement of parallel beam of light. Accordingly, the said waveguide (10) finds an important application in the field of colorimetric analysis, wherein a parallel beam of light is required to pass through a liquid sample for accurately determining the optical density (absorbance) of the sample.

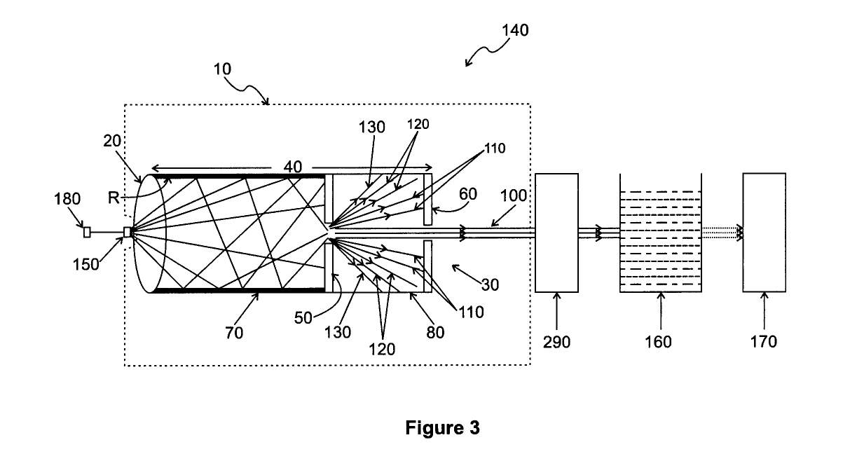

FIG. 3, shows an apparatus (140) for determining optical density of a liquid sample according to the present invention.

As shown in FIG. 3, the said apparatus (140) comprises of a light source (150), an optical waveguide (10), a cuvette (160) and a photo detector (170). The light source (150) when energized by a constant voltage power source (180) emits a divergent beam which is incident onto the optical waveguide (10). The optical waveguide (10) is arranged in an optical path between the light source (150) and the cuvette (160) for receiving the divergent beam at its input and providing an illuminating beam at its output. The cuvette (160) is located adjacent to the output of the optical waveguide (10) and is configured to hold the liquid sample, optical density of which is to be measured. The photo detector (170) is located adjacent to the cuvette (160) such that the cuvette (160) is sandwiched between the optical waveguide (10) and the photo detector (170).

The said optical waveguide (10) is in the form of a cylinder and is defined by an input end (20), an output end (30) and a longitudinal cavity (40). The longitudinal cavity (40) extends from the input end (20) till output end (30) and defines a space for propagation of light. The waveguide (10) comprises of a first pinhole (50) located at a first predetermined distance from the input end (20) within the said cavity (40) and a second pinhole (60) located at the output end (30) of the said cavity (40). The first pinhole (50) is located such that it bifurcates the longitudinal cavity (40) into a first light propagating region (70) and a second light propagating region (80). The first predetermined distance is selected such that the first light propagating region (70) is substantially long as compared to the second light propagating region (80).

The light source (150) is located in close proximity to the input end (20) and when energized by the constant voltage power source (180) emits a divergent beam which is incident onto the input end (20) of the optical waveguide (10). The input end (20) is configured for receiving the divergent beam and for directing the same into the first light propagating region (70). The first light propagating region (70) is provided with a reflective coating (R) on its internal surface to enable internal reflection of the divergent beam. The divergent beam after experiencing reflection within the first light propagating region (70) is incident onto the first pinhole (50). The first pinhole (50) is configured for receiving the divergent beam and for generating a fringe pattern (90).

The fringe pattern (90) generated by the first pinhole (50) is referred to as “illuminating beam” and is shown in FIG. 2. As shown in FIG. 2, the fringe pattern (90) comprises of a central bright fringe (100), a first bright fringe (110), a second bright fringe (120) and a third bright fringe (130). It should be noticed that fourth, fifth and further bright fringes also exist, however they are not shown as their intensity is very low. Further, it should be noted that the central bright fringe has the maximum intensity and the intensity decreases with the increase in the order of the fringes.

The fringe pattern (90) generated by the first pinhole (50) propagates through the second light propagating region (80) and is incident onto the second pinhole (60). The second pinhole (60) is configured for receiving the fringe pattern (90) generated by the first pinhole (50) and for directing the illuminating beam corresponding to the central bright fringe (100) onto the cuvette (160) via the output end (30). In other words, the second pinhole (60) allows only the illuminating beam corresponding to the central bright fringe (100) to pass through and blocks the illuminating beam corresponding to rest of the fringes.

The illuminating beam corresponding to the central bright fringe (100) is at zero degree angle of incidence with respect to the cuvette (160). The illuminating beam corresponding to the central bright fringe (100) enters the cuvette (160) with intensity Io and leaves the cuvette (160) with intensity I. In other words, some amount of light is absorbed by the liquid sample in the cuvette (160) and the rest is transmitted.

A measuring beam with intensity I after leaving the cuvette (160) is incident onto the photo detector (170). The photo detector (170) is arranged to detect the intensity of the measuring beam or transmitted beam. The transmittance of the liquid sample in the cuvette (160) can be determined by determining the intensity of the measuring beam or transmitted beam.

Since, the illuminating beam corresponding to the central bright fringe (100) is at zero degree angle of incidence with respect to the cuvette (160) it does not undergo refraction when it enters the cuvette (160). In other words, the illuminating beam corresponding to the central bright fringe (100) does not under go a distance shift when it enters the cuvette (160). As no refraction of illuminating beam takes place, errors caused due to refraction of light are minimized. More specifically, the optical waveguide (10) is arranged in a way that it minimizes the errors caused due to refraction of light. Since, no errors are introduced, the transmittance of the liquid sample can be determined accurately. Once the transmittance is determined accurately, the optical density (absorbance) can be determined accurately.

The following equations describe the determination of optical density (absorbance) of the liquid sample:

Transmittance or transmissivity (T) of the liquid sample in the cuvette (160) is given by:

$$T = \frac{I}{Io}$$

where I represents intensity of light that has passed through the liquid sample i.e. intensity of the measuring beam and Io represents intensity of light before it enters the cuvette (160) i.e. intensity of the illuminating beam corresponding to the central bright fringe (100).

The optical density or absorbance (A) of the liquid sample in the cuvette (160) is given by:

A=−log₁₀ (T)

The concentration of the liquid sample in the cuvette (160) is determined based on the calculated value of the optical density or absorbance (A) using conventionally known techniques.

The following tables show the comparison between concentration results obtained using conventional apparatuses and the apparatus of the present invention.

TABLE 1

| | Known | Measured value of | |
|---|---|---|---|
| S. no | concentration (mg/ml) | concentration (mg/ml) | Error (%) |
| 1. | 1.5625 | 1.495 | 4.32 |
| 2. | 3.125 | 2.93 | 6.24 |
| 3. | 6.25 | 5.977 | 4.37 |
| 4. | 12.5 | 11.328 | 9.38 |
| 5. | 25 | 23.046 | 7.82 |

Table 1, shows the measurement results for the concentration of Potassium dichromate, obtained using the conventionally known spectrophotometer provided by Simatzu.

TABLE 2

| | Known | Measured value of | |
|---|---|---|---|
| S. no | concentration (mg/ml) | concentration (mg/ml) | Error (%) |
| 1. | 1.5625 | 1.18 | 24.48 |
| 2. | 3.125 | 2.34 | 25.12 |
| 3. | 6.25 | 4.29 | 31.36 |
| 4. | 12.5 | 8.20 | 34.4 |
| 5. | 25 | 15.62 | 37.52 |

Table 2, shows the measurement results for the concentration of Potassium dichromate, obtained using the conventionally known colorimeter DTL 1005 provided by DTL Pro, Elico, Alpine.

TABLE 3

| | Known | Measured value of | |
|---|---|---|---|
| S. no | concentration (mg/ml) | concentration (mg/ml) | Error (%) |
| 1. | 1.5625 | 1.54 | 1.44 |
| 2. | 3.125 | 3.04 | 2.72 |
| 3. | 6.25 | 6.03 | 3.52 |
| 4. | 12.5 | 12.23 | 2.16 |
| 5. | 25 | 24.24 | 3.04 |

Table 3, shows the measurement results for the concentration of Potassium dichromate, obtained using the apparatus (140) of the present invention.

The results shown in table 3 are obtained using the following values:

1. Length of the first light propagating region=38.5 mm

2. Length of the second light propagating region=12.5 mm

3. Diameter of the optical waveguide=8.8 mm

4. Size of the first pinhole=0.1 mm

5. Size of the second pinhole=0.1 mm

It is important to note that, length of the first and second light propagating regions, diameter of the optical waveguide and size of the first and second pinholes are not restricted to the above mentioned values. The length of the first and second light propagating regions, diameter of the optical waveguide and size of the first and second pinholes can have other values depending on the type of applications.

From Table 1, it can be noticed that the measured values of concentration obtained using the Spectrophotometer provided by Simatzu does not match with the actual values and the measurement results exhibits error.

From Table 2, it can be noticed that the measured values of concentration obtained using the colorimeter provided by DTL Pro, Elico, Alpine exhibits a large amount of error and are highly non linear. The error encountered in colorimeters provided by DTL Pro, Elico, Alpine is much higher than the error encountered in Spectrophotometers provided by Simatzu.

From Table 3, it can be noticed that the measured values of concentration obtained using the apparatus (140) of the present invention closely matches with the actual values. Table 3, illustrates that the measurement results obtained by the apparatus (140) of present invention exhibit a lesser amount of error as compared to the Spectrophotometer provided by Simatzu and colorimeter provided by DTL Pro, Elico, Alpine. The apparatus (140) of present invention provides an accurate measurement of concentration, wherein the error lies in the tolerance band.

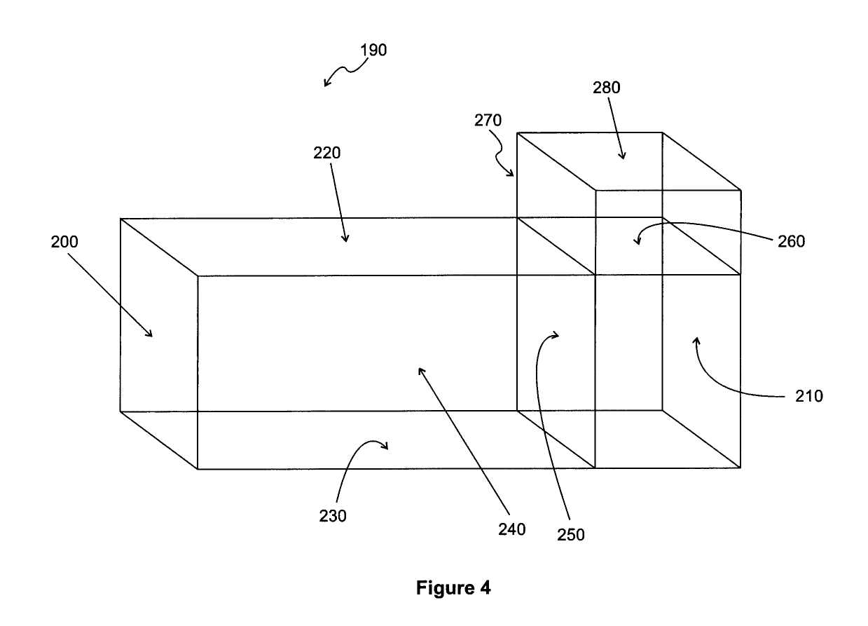

In an aspect of the present invention, the apparatus (140) further comprises a longitudinal casing (190) encapsulating the said light source (150), optical wave guide (10), cuvette (160) and photo detector (170) into a single unit. FIG. 4 shows the front view of the longitudinal casing (190) according to an aspect of the present invention.

As shown in FIG. 4, the said longitudinal casing (190) is defined by an open proximal end (200), an open distal end (210), a top wall (220), a bottom wall (230), a front wall (240) and a rear wall (not shown).

The said light source (150) and photo detector (170) are securely fitted at the proximal and distal ends respectively, wherein the said light source (150) and photo detector (170) seals the proximal and distal ends respectively. Further, the said optical waveguide (10) is securely fitted inside the longitudinal casing (190) extending from the proximal end (200) till an intermediate end (250).

The top wall (220) is provided with a slot (260) in close proximity to the distal end (210) for holding the said cuvette (160). Optionally, the top wall (220) is provided with a protrusion (270) extending vertically upwards from the said slot (260) for providing additional support to the cuvette (160), wherein said protrusion (270) is provided with an opening (280) concurrent to the said slot (260).

In another aspect of the present invention, the light source (150) may be a monochromatic light source.

In another aspect of the present invention, the light source (150) may be a white light source. If the light source (150) is a white light source, the apparatus (140) further comprises an optical filter (290). As shown in FIG. 3, the optical filter (290) is located between the optical waveguide (10) and the cuvette (160) for selecting a predetermined wavelength of the illuminating beam. The optical filter (290) may be a monochromatic filter that allows only a narrow range of wavelength (that is a single color) to pass through and blocks rest of the wavelengths. Depending on the wavelength of light to be measured a suitable monochromatic filter may be used.

In yet another aspect of the present invention, the light source (150) may be a light emitting diode (LED) or a halogen lamp or any other source of light emitting a divergent beam.

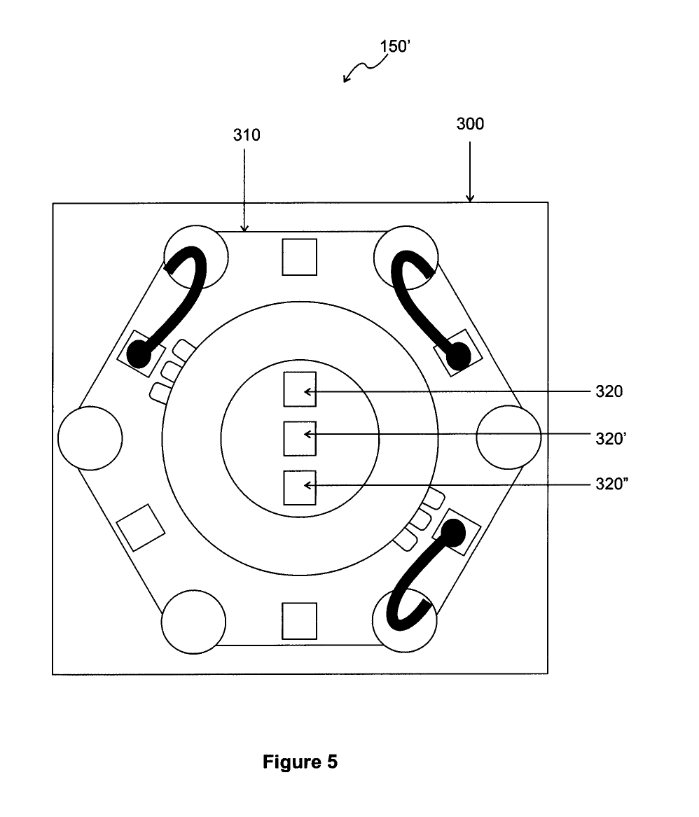

In yet another aspect of the present invention, the light source may comprise a plurality of light emitting diodes or halogen lamps. FIG. 5, shows the light source (150′) according to this aspect of the present invention. As shown in FIG. 5, the light source (150′) comprises of a heat sink (300), a printed circuit board (310) mounted over said heat sink (300) and a plurality of light emitting diodes (320, 320′, 320″) mounted randomly over said printed circuit board (310). It is to be noted that the said light source (150′) is configured to emit a divergent beam i.e. only one light emitting diode is energized at a particular instant of time.

The importance of this aspect is that the apparatus (140) and more particularly the optical waveguide (10) of the present invention works for different locations of the light source and generates a parallel beam of light for different locations of the light source. In contrast, conventional apparatuses such as Spectrophotometer provided by Simatzu and colorimeter provided by DTL Pro, Elico, Alpine are designed to operate for a particular location of the light source i.e. the light source should be located at a position that is coinciding with the axis of the optical system used in the said apparatuses.

On the other hand, the apparatus (140) and more particularly the optical waveguide (10) of the present invention generate a parallel beam of light irrespective of the location of the light source. For instance, as shown in FIG. 5, the light source (150′) comprises of three light emitting diodes (320, 320′, 320″) mounted randomly over the printed circuit board (310). More specifically, the light emitting diode (320) is located at a distance of 3 mm above the axis (330) of the optical waveguide (10), the light emitting diode (320′) is located at a distance of 1 mm above the axis (330) of the optical waveguide (10) and the light emitting diode (320″) is located at a distance of 2 mm below the axis (330) of the optical waveguide (10).

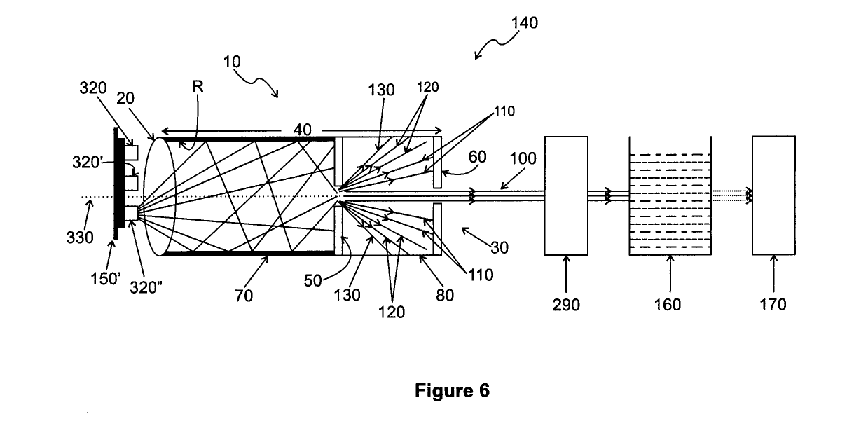

FIG. 6, shows the apparatus (140) equipped with the light source (150′). It is important to note that, none of the three light emitting diodes (320, 320′, 320″) is located at a position that coincides with the horizontal axis of the waveguide (10). Even with such a construction, the apparatus (140) and more particularly the optical waveguide (10) is able to generate a parallel beam of light for all the three light emitting diodes.

In still another aspect of the present invention, the pinhole may be a very small opening in a metallic sheet, or cardboard, or paper.

In still another aspect of the present invention, the size of the first and second pinholes may be same or different.

In a further aspect of the present invention, the reflective coating (R) may be nickel coating or aluminum coating or any other metal coating or alloy coating.

In a still further aspect of the present invention, an optimum combination of length of the first light propagating region and diameter of the optical waveguide is required to obtain an illuminating beam corresponding to the central bright fringe having sufficient intensity.

The foregoing detailed description has described only a few of the many possible implementations of the present invention. Thus, the detailed description is given only by way of illustration and nothing contained in this section should be construed to limit the scope of the invention. The claims are limited only by the following claims, including the equivalents thereof.

1. An optical waveguide, comprising:
an input end for receiving a divergent beam;
an output end for outputting an illuminating beam;
a longitudinal cavity extending from the input end till the output end;
a first pinhole located at a first predetermined distance from the input end within the said longitudinal cavity for receiving the divergent beam and for generating a fringe pattern, said first pinhole bifurcating the longitudinal cavity into a first and a second light propagating regions, the longitudinal cavity forming the first light propagating region being provided with a reflective coating on its internal surface to enable internal reflection of the divergent beam; and
a second pinhole located at the output end for receiving the fringe pattern thus generated by the first pinhole and for outputting the illuminating beam corresponding to a central bright fringe contained in the said fringe pattern via the output end.

2. The optical waveguide as claimed in claim 1, wherein the first predetermined distance is selected such that the first light propagating region is substantially long as compared to the second light propagating region.

3. The optical waveguide as claimed in claim 1, wherein the illuminating beam corresponding to the central bright fringe is at zero degree angle of incidence with respect to the second pinhole.

4. The optical waveguide as claimed in claim 1, wherein the waveguide is in the form of a cylinder.

5. An apparatus for determining optical density of a liquid sample, said apparatus comprising:
a light source emitting a divergent beam;
an optical waveguide for receiving the divergent beam at its input and providing an illuminating beam at its output;
a cuvette located adjacent to the output of the optical waveguide and configured to hold the liquid sample; and
a photo detector located adjacent to the cuvette such that the cuvette is sandwiched between the photo detector and the optical waveguide;
characterized in that the optical waveguide comprises:
an input end for receiving the divergent beam;
an output end for outputting the illuminating beam;
a longitudinal cavity extending from the input end till the output end;
a first pinhole located at a first predetermined distance from the input end within the said longitudinal cavity for receiving the divergent beam and for generating a fringe pattern, said first pinhole bifurcating the longitudinal cavity into a first and a second light propagating regions, the longitudinal cavity forming the first light propagating region being provided with a reflective coating on its internal surface to enable internal reflection of the divergent beam; and
a second pinhole located at the output end for receiving the fringe pattern thus generated by the first pinhole and for directing the illuminating beam corresponding to a central bright fringe contained in the said fringe pattern onto the said cuvette via the output end.

6. The apparatus as claimed in claim 5, wherein the first predetermined distance is selected such that the first light propagating region is substantially long as compared to the second light propagating region.

7. The apparatus as claimed in claim 5, wherein the illuminating beam corresponding to the central bright fringe is at zero degree angle of incidence with respect to the cuvette.

8. The apparatus as claimed in claim 5, wherein the waveguide is in the form of a cylinder.

9. The apparatus as claimed in claim 5, wherein the light source is a monochromatic light source or a white light source.

10. The apparatus as claimed in claim 9, wherein when the light source is a white light source, the apparatus further comprises:
an optical filter located between the optical waveguide and the cuvette for selecting a predetermined wavelength of the illuminating beam.

11. The apparatus as claimed in claim 5, wherein the optical waveguide is securely fitted inside a longitudinal casing having open proximal and distal ends.

12. The apparatus as claimed in claim 11, wherein a top wall of the longitudinal casing is provided with a slot in close proximity to the distal end to hold the cuvette.

13. The apparatus as claimed in claim 11, wherein the light source is securely fitted at the proximal end.

14. The apparatus as claimed in claim 11, wherein the photo detector is securely fitted at the distal end.

15. The apparatus as claimed in claim 12, wherein said top wall is provided with a protrusion extending vertically upwards from said slot for providing support to the cuvette, said protrusion being provided with an opening concurrent to the said slot.

16. An optical waveguide and an apparatus for determining optical density of a liquid sample substantially as herein described with reference to the foregoing specification and accompanying drawings.
